(19) United States
(12) Patent Application Publication
(10) Pub. No.: US 2024/0278913 A1
(43) Pub. Date: Aug. 22, 2024

(54) FLIGHT EQUIPMENT AND OPERATION METHOD

(71) Applicant: Japan Aerospace Exploration Agency, Tokyo (JP)

(72) Inventors: Daichi WADA, Chofu-shi (JP); Atsushi OSEDO, Chofu-shi (JP)

(21) Appl. No.: 18/569,965

(22) PCT Filed: Jul. 6, 2022
(86) PCT No.: PCT/JP2022/026858

§ 371 Date: Dec. 13, 2023

(30) Foreign Application Priority Data
Jul. 8, 2021 (JP) 2021-113544

(51) Int. Cl. B64C 39/02; B64C 3/56; B64C 15/02; B64D 45/00

(52) U.S. Cl. CPC B64C 39/026; B64C 3/56; B64C 15/02; B64D 45/00

(57) ABSTRACT

This flight equipment (100) includes a thrust device (10) that provides thrust during flight, wings (20) that maintain an attitude during flight and change a direction of flight, a control unit that controls strength of an output from the thrust device (10), and an attachment and detachment unit (30) that can be worn or removed by a user (H).

### TECHNICAL FIELD

The present invention relates to flight equipment and an operation method.

Priority is claimed on Japanese Patent Application No. 2021-113544, filed Jul. 8, 2021, the content of which is incorporated herein by reference.

### BACKGROUND ART

Flight equipment that allows humans to fly equipped with a propulsion system has been developed (for example, Non-Patent Documents 1 to 3). The flight equipment is used, for example, to help move rescue workers in order to contribute to mountain rescue.

### CITATION LIST

### Non-Patent Document

[Non-Patent Document 1]
Flight Club—Gravity Industries, [online]. [Retrieved on 18 Jun. 2021], Retrieved from the internet: <URL: https://gravity.co/>
[Non-Patent Document 2]
Home—Speeder, JetPack Aviation, [online]. [Retrieved on 18 Jun. 2021], Retrieved from the internet: <URL: https://jetpackaviation.com/>
[Non-Patent Document 3]
The first Jetman Yves Rossy, [online]. [Retrieved on 18 Jun. 2021], Retrieved from the internet: <URL: https://yvesrossy.com/>

### SUMMARY OF INVENTION

### Technical Problem

In addition to obtaining thrust from a jet engine, conventional flight equipment performs attitude control and direction change during flight with the jet engine. Therefore, a flight time is limited from the viewpoint of fuel economy.

In addition, it is assumed that the flight equipment is operated in a state in which it is equipped by an operator (human). For this reason, it is difficult for the operator to perform the attitude control, and there is a problem that sufficient flight performance cannot be obtained or that it takes time to become proficient.

The present invention has been made in view of the circumstances described above, and an object thereof is to provide flight equipment that has high flight performance and does not require a highly skilled operation for which proficiency takes a long time.

### Solution to Problem

In order to solve the above problems, the present invention proposes the following means.

Flight equipment according to the present invention includes a thrust device configured to provide thrust during flight, wings configured to maintain an attitude during flight and to change a direction of flight, a control unit configured to control strength of an output of the thrust device, and an attachment and detachment unit configured to be worn or removed by a user.

According to the present invention, it is possible to receive an aerodynamic force during flight by providing the wings. Therefore, it is possible to effectively and stably perform attitude control compared to a case of flying on a bullet trajectory like a rocket without the wings. In addition, the attitude can be stabilized even during takeoff and landing including vertical takeoff and landing. In addition, a lift force generated by the wings reduces the thrust required for flight and improves fuel economy of the thrust device. Therefore, flight time and flight duration can be improved. From these points, high flight performance can be provided.

Further, the strength of the thrust is controlled by the control unit. Thus, since the user only needs to perform a simple operation such as acceleration or deceleration and a direction change by the wings, a more intuitive operation can be achieved. Therefore, the flight equipment does not require a highly skilled operation.

Furthermore, the attachment and detachment unit that the user can wear and remove easily is provided. Thus, the flight equipment can be shared by a plurality of people.

Further, the control unit may control a flight attitude and a flight direction due to the wings and the output of the thrust device.

According to the present invention, the control unit performs the control of the flight attitude and the flight direction by the wings and the control of the output of the thrust device. Thus, autonomous flight by the flight equipment is possible. Thus, the user can fly without performing any operation. Therefore, a piloting skill of the user can be made unnecessary.

Furthermore, it is possible to perform autonomous solo flight only with the flight equipment without being worn by the user. In other words, when a plurality of users (for example, rescue workers) are going to move from the departure point to the destination, one user moves from the departure point to the destination, and then only the flight equipment can return to the departure point by autonomous flight. Therefore, even when the plurality of users move from the departure point to the destination, the one piece of flight equipment can be used. Therefore, it is possible to contribute to efficient rescue operations without providing a plurality of pieces of flight equipment.

Further, an attitude sensor configured to detect an attitude of the flight equipment may be further provided.

According to the present invention, the attitude sensor is further provided. More stable autonomous flight can be achieved using information detected by the attitude sensor for control by the control unit. Furthermore, even when the user flies with his/her own skill, more stable flight can be achieved by supplementally using information from the attitude sensor.

Further, a position sensor configured to grasp a flying point may be further provided.

According to the present invention, the position sensor is further provided. Thus, for example, the control unit can select the shortest route for flight by registering the departure point and the destination in the flight equipment in advance.

Further, a communication unit configured to communicate with the outside may be further provided.

According to the present invention, the communication unit is further provided. Thus, the flight can be performed by remote control from the outside, in addition to the piloting by the user and the flight controlled by the control unit.

Further, the wings may be configured to be folded.

According to the invention, the wings are foldable. Therefore, it is possible to improve mobility when the flight equipment is carried. Furthermore, during high-speed flight, the wings can be retracted to reduce resistance, and during low-speed flight or takeoff and landing, the wings can be deployed to make it easier to obtain the aerodynamic force. Therefore, it is possible to further improve the mobility.

Further, an operation method according to the present invention is an operation method in which a plurality of users share the flight equipment, wherein, after a user wears the flight equipment and flies from a departure point to a destination using the flight equipment, only the flight equipment flies from the destination to the departure point.

According to the present invention, after the user wears the flight equipment and flies from the departure point to the destination using the flight equipment, only the flight equipment flies from the destination to the departure point. Thus, one piece of flight equipment can be shared by the plurality of users. Therefore, it is not necessary to prepare a plurality of pieces of flight equipment, and a plurality of people can be moved.

### Advantageous Effects of Invention

According to the present invention, it is possible to provide flight equipment that has high flight performance and does not require a highly skilled operations for which proficiency takes a long time.

### BRIEF DESCRIPTION OF DRAWINGS

FIG. 1 is a schematic diagram of one embodiment of flight equipment according to the present invention.

FIG. 2 is an overall schematic diagram showing an example of the flight equipment according to the present invention.

FIG. 3 is a diagram showing an example of a configuration of a flight control device in a first example of control.

FIG. 4 is a diagram showing an example of an attitude control system using quaternion feedback.

FIG. 5 is a flowchart showing a series of processes performed by a control unit.

FIG. 6 is a diagram schematically showing a state in which the flight equipment flies.

FIG. 7 is a diagram showing an example of a configuration of a flight control device in a second example of control.

### DESCRIPTION OF EMBODIMENTS

Hereinafter, flight equipment according to an embodiment of the present invention will be described with reference to the drawings.

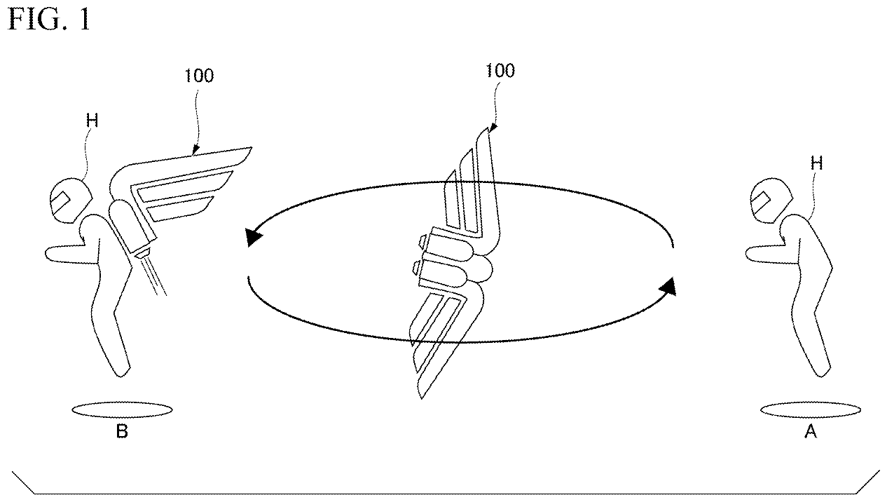

As shown in FIG. 1, the flight equipment 100 is used by a user H to fly in the air in a state in which the user H wears it and to move from a departure point A to a destination B. Also, a plurality of users H can use the flight equipment 100. For example, after one user H wears the flight equipment 100 and moves from the departure point A to the destination B, the user H removes the flight equipment 100. After that, an autonomous solo flight is performed using only the flight equipment 100, and the flight equipment 100 returns from the destination B to the departure point A. In this way, one piece of flight equipment 100 is shared by a plurality of people.

The flight equipment 100 according to this embodiment is used for the following applications as an example. That is, for example, it is used by a mountain rescue team to move from a headquarters base (the departure point A) set up at the foot of a mountain to a rescue site (the destination B) on a mountain trail using an air route. Also, after a first rescue worker arrives at the destination B, the flight equipment 100 returns to the departure point A by itself, so that a second rescue worker goes to the rescue site. By repeating this, one piece of flight equipment 100 is used to dispatch a plurality of rescue workers to the destination. In addition to the application described above, it may also be used to transport a person to be rescued on the ground to a waiting helicopter in the air.

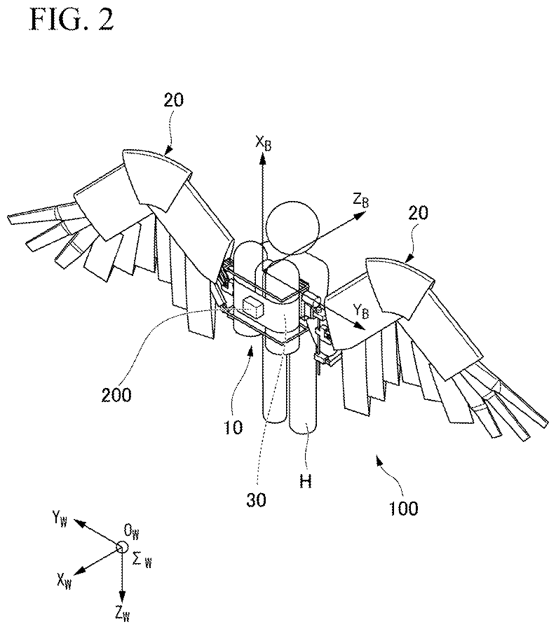

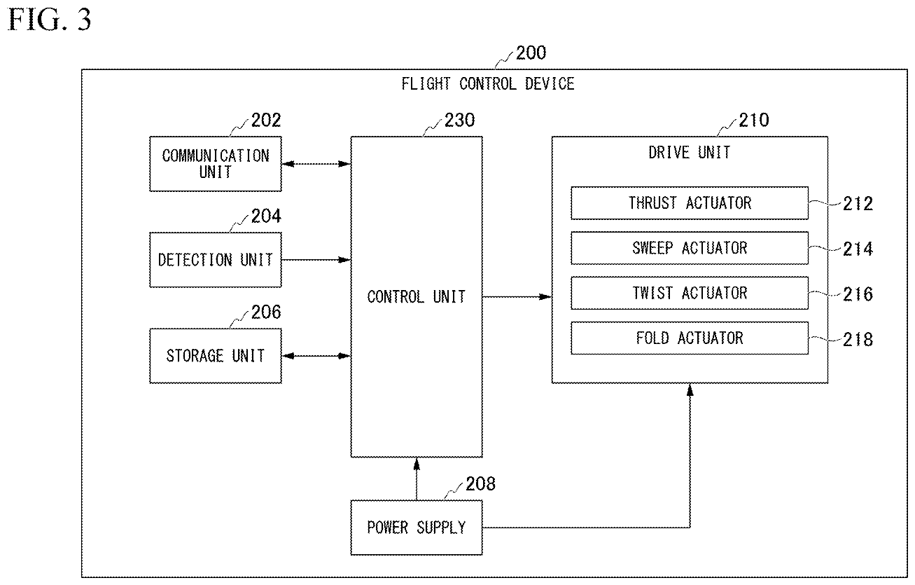

As shown in FIGS. 2 and 3, the flight equipment 100 includes a thrust device 10, wings 20, a control unit 230, an attachment and detachment unit 30, a detection unit 204, a communication unit 202, a storage unit 206, a power supply 208, and a drive unit 210. Hereinafter, the control unit 230, the communication unit 202, the detection unit 204, the storage unit 206, the power supply 208, and the drive unit 210 which are used to control the flight equipment 100 may be referred to as a flight control device 200.

Σ_{W} shown in FIG. 2 represents one earth-fixed coordinate Σ_{W} of the inertial coordinate system, O_{W} represents the origin of the earth-fixed coordinate Σ_{W}, an X_{W} axis represents true north, a Y_{W} axis represents east, and a Z_{W} axis represents a vertically downward direction. Further, when the principal axis of inertia is defined as a fuselage-fixed coordinate system of the flight equipment 100, in the drawing, an X_{B} axis represents a principal axis of inertia of a fuselage when the center of gravity of the flight equipment 100 is taken as the origin, a Z_{B} axis represents a downward direction of the fuselage, and a Y_{B} axis represents a rightward direction in a traveling direction of the fuselage. In other words, the X_{B} axis represents a roll axis X_{B}, the Z_{B} axis represents a yaw axis Z_{B}, and the Y_{B} axis represents a pitch axis Y_{B}.

The thrust device 10 provides thrust during flight. A known jet engine, for example, is preferably used as the thrust device 10. An output of the thrust device 10 is controlled by the control unit 230 (which will be described below).

The wings 20 maintain an attitude during flight and change the direction of flight. The change of direction by the wings 20 may be operated by the control unit 230 that receives an input signal from the user H, or may be controlled by the control unit 230 that acquires results from various sensors.

In this embodiment, the size of each of the wings 20 is appropriately determined in consideration of a physique including a height and a weight of the user H who uses the flight equipment 100.

In this embodiment, each of the wings 20 has a link mechanism and can be folded like a bird's wing. The above wing span is for the wing 20 in a spread state. Since the wing 20 can be folded, it has the following functions. That is, during high-speed flight, the wings 20 are folded to reduce air resistance, and during low-speed flight and takeoff and landing, the wings 20 are spread to obtain an aerodynamic force. Further, the wings 20 may be folded when the flight equipment 100 is not in use, thereby contributing to mobility during transportation. Moreover, the present invention is not limited thereto, and the wings 20 may have a structure that can be deployed and retracted by providing a telescopic structure instead of being folded. Alternatively, it may be flat shape without a foldable structure.

In addition, the wing 20 according to this embodiment includes various actuators in addition to the link mechanisms described above, and are capable of rotating around the roll axis X_{B}, the yaw axis Z_{B}, and the pitch axis Y_{B} shown in FIG. 2 (which will be described below).

The control unit 230 controls the strength of the output of the thrust device 10. Specifically, the thrust is increased or decreased according to conditions of high-speed flight, low-speed flight, and takeoff and landing. Thus, it contributes to more stable flight. The above-described output control may be performed by the control unit 230 receiving an input from the user H via an interface (not shown). Alternatively, the control unit 230 may perform autonomous control based on a variety of information provided from the detection unit 204 (which will be described below).

Also, as described above, the control unit 230 may control a flight attitude and a flight direction by the wings 20. That is, the control unit 230 may receive an input from the user H via an interface regarding a shape and orientation of the wings 20, and the control unit 230 may appropriately operate actuators provided on the wings 20. Alternatively, the control unit 230 may control the wings 20 based on a variety of information provided by the detection unit 204 (described below) (hereinafter, control based on information from a sensor unit that does not depend on the user input is referred to as autonomous control).

In this way, the control unit 230 controls the thrust device 10 and the wings 20 by receiving an operation by the user H via the interface or by the autonomous control. In other words, the control unit 230 may be used to complement the operation by the user H, or may be used for autonomous solo flight of the flight equipment 100.

The attachment and detachment unit 30 is used by the user H to wear the flight equipment 100. Moreover, the attachment and detachment unit 30 is made into a structure that the user H can wear or remove easily. For example, a structure including a structure to be hung on the shoulder like a general backpack and a fastener for fixing to the user H may be used. Alternatively, in a state in which each of the users H is equipped with an attachment member having a shape corresponding to the attachment and detachment unit 30, the attachment member and the attachment and detachment unit 30 may be appropriately fixed.

The detection unit 204 detects each state of the flight equipment 100 in a flight state. The detection unit 204 includes, for example, an attitude sensor, a position sensor, and an acceleration sensor.

The attitude sensor detects an attitude of the flight equipment 100 during flight. Specifically, the rotation angle in each of the three-dimensional axial directions is detected with respect to an arbitrary reference attitude (for example, a state in which the user H wears the flight equipment 100 and stands perpendicular to the ground).

The position sensor detects a position of the flight equipment 100 during flight. For example, a known GPS sensor is preferably used as the position sensor. Further, according to a distance between the departure point A and the destination B, the position may be grasped by transmitting radio waves from the departure point A or the destination B and detecting them with a radar. Thus, it is confirmed whether the flight equipment 100 moves from the departure point A to the destination B along a planned route.

The acceleration sensor detects the acceleration or speed of the flight equipment 100 during flight. Thus, the control when the flight equipment 100 performs autonomous flight is complemented.

The control unit 230 uses the information detected by the above-described sensors to control the thrust device 10 and the wings 20, thereby stabilizing flight control. Information from the detection unit 204 may be used when the thrust device 10 and the wing 20 of the flight equipment 100 are autonomously controlled by the control unit 230 as described above. In addition, even when the flight equipment 100 is being operated by the user H, it may be used to complement the operation by the user H.

The communication unit 202 is used to communicate between the flight equipment 100 and the outside. The communication unit 202 is used, for example, to transmit similar operation information from the outside to the control unit 230 in place of the operation of the thrust device 10 and the wings 20 by the user H during flight. In this way, when a piloting skill of the user H is inexperienced and autonomous solo flight by the control unit 230 is impossible, it is used for external maneuvering by an operator skilled in piloting. Alternatively, it may be used to contact the user H in flight, such as changing the destination B.

### [Configuration of Flight Control Device]

A configuration of the flight control device 200 will be described below with reference to FIGS. 3, 4, 5, 6, and 7. Control described below is an example of control applied when the above-described flight equipment 100 performs autonomous solo flight. In other words, the control of the flight equipment 100 does not have to be based on the control described below.

### [First Example of Control]

FIG. 3 is a diagram showing an example of the configuration of the flight control device 200 in a first example of control. The flight control device 200 includes, for example, a communication unit 202, a detection unit 204, a storage unit 206, a power supply 208, a drive unit 210, and a control unit 230. Further, the control of the wings 20 in the following will be described assuming that the wings 20 can be rotated around the roll axis X_{B}, the yaw axis Z_{B}, and the pitch axis Y_{B} shown in FIG. 2, or can be folded.

The communication unit 202 performs wireless communication with an external device via a network such as a wide area network (WAN), for example. The external device may be, for example, a remote controller capable of remotely operating the flight equipment 100. For example, the communication unit 202 receives a command that instructs the attitude, a speed, and the like that the flight equipment 100 should take from an external device.

The detection unit 204 includes, for example, an inertial measurement device in addition to the sensors described above. The inertial measurement device include, for example, a triaxial acceleration sensor and a triaxial gyro sensor. The inertial measurement device outputs detection values detected by the sensors to the control unit 230. The detection values detected by the inertial measurement device include, for example, accelerations and/or angular velocities in the horizontal, vertical, and depth directions, and velocities (rates) in the pitch, roll, and yaw axes. The detection unit 204 may further include a radar, a finder, a sonar, a global positioning system (GPS) receiver, and the like. Moreover, the detection unit 204 may further include an optical fiber sensor that detects the strain of the wings 20 and a pressure sensor that detects the pressure applied to the wings 20.

The storage unit 206 is implemented by a storage device such as a hard disc drive (HDD), a flash memory, an electrically erasable programmable read only memory (EEPROM), a read only memory (ROM), a random access memory (RAM), or the like. The storage unit 206 stores calculation results of the control unit 230 as logs, in addition to various programs such as firmware and application programs.

The power supply 208 is, for example, a secondary battery such as a lithium ion battery. The power supply 208 supplies power to the drive unit 210 and the control unit 230. The power supply 208 may also include solar panels and the like.

The drive unit 210 includes, for example, a thrust actuator 212, a sweep actuator 214, a twist actuator 216 and a fold actuator 218.

The thrust actuator 212 drives the thrust device 10 to provide thrust to the flight equipment 100. The sweep actuator 214 rotates the wings 20 around the yaw axis Z_{B}.

The twist actuator 216 rotates the wings 20 around the pitch axis Y_{B}. The fold actuator 218 spreads or folds the wings 20 in the direction of the pitch axis Y_{B}.

The control unit 230 is realized, for example, by a processor such as a central processing unit (CPU) or a graphics processing unit (GPU) executing a program stored in the storage unit 206. In addition, the control unit 230 may be realized by hardware such as a large scale integration (LSI), an application specific integrated circuit (ASIC), or a field-programmable gate array (FPGA), and may be realized by cooperation of software and hardware.

A first example of control content of the control unit 230 will be described below. The control unit 230 drives the thrust device 10 by controlling the thrust actuator 212 when the flight equipment 100 is in a 90-degree pitch-up state, that is, when the flight equipment 100 is in a state in which the flight equipment 100 rises directly upward due to the thrust device 10. Thus, the flight equipment 100 takes off like a tail-sitter type vertical takeoff and landing (VTOL) drone. The tail-sitter type is a flight type in which the flight equipment 100 takes off from the 90-degree pitch-up state, returns the nose to a horizontal position at a certain altitude, and flies with the lift force generated by the wings 20.

Since such a tail-sitter type has a large attitude change, if ZYX Euler is used to calculate an attitude error, when the Z_{B} axis is plus or minus 90 degrees during takeoff and landing, it becomes a singular attitude and cannot be expressed. Further, in flight mimicking a bird using the wings 20 according to this embodiment, there is a high probability that a large attitude change will occur, and thus attitude expression without a singular attitude is necessary. To solve this problem, a quaternion is employed to calculate the attitude error. The quaternion is represented by Equation (1) using a three-dimensional unit vector r and a rotation angle ζ thereof.

$$[ Equation 1 ]$$

$$q = [ \begin{matrix}cos ( ζ / 2 ) \\ r sin ( ζ / 2 )\end{matrix} ] = {[ \begin{matrix}{q}_{0} & {q}_{1} & {q}_{2} & {q}_{3}\end{matrix} ]}^{T} \qquad ( 1 )$$

When it is assumed that qᵣ is a target attitude and q_{c} is a current attitude, a deviation qₑ between the target attitude and the current attitude is expressed by Equation (2) using a quaternion matrix.

$$[ Equation 2 ]$$

$${q}_{e} = [ \begin{matrix}{q}_{r o} & {q}_{r 1} & {q}_{r 2} & {q}_{r 3} \\ - {q}_{r 1} & {q}_{r o} & {q}_{r 3} & - {q}_{r 2} \\ - {q}_{r 2} & - {q}_{r 3} & {q}_{r o} & {q}_{r 1} \\ - {q}_{r 3} & {q}_{r 2} & - {q}_{r 1} & {q}_{r o}\end{matrix} ] {q}_{c} \qquad ( 2 )$$

The deviation qₑ indicates how much rotation should be done around which axis in a current fuselage-fixed coordinate system in order to bring the current attitude of the fuselage closer to the target attitude. For example, the control unit 230 performs feedback control by making a vector part of qₑ correspond to the fuselage-fixed coordinate X_{B}, Y_{B}, and Z_{B} axes.

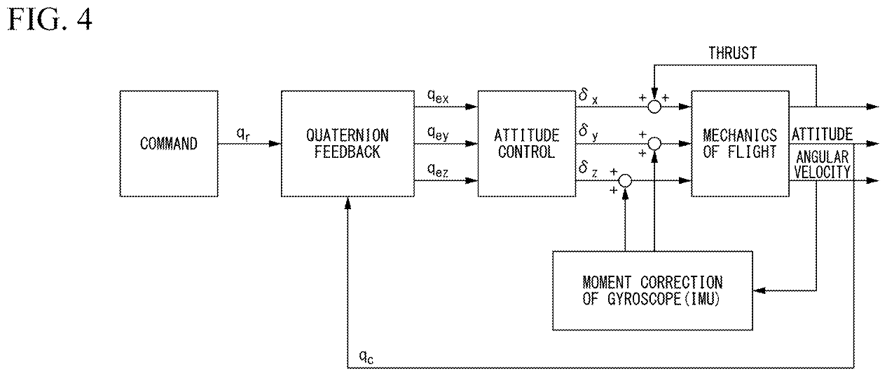

FIG. 4 is a diagram showing an example of an attitude control system using quaternion feedback. For example, the control unit 230 controls the sweep actuator 214, the twist actuator 216, and the fold actuator 218 to control the attitude of the flight equipment 100 in the X_{B}, Y_{B}, and Z_{B} axes.

The control unit 230 performs proportional-integral-differential controller (PID) control of the actuators corresponding to each of the axes. The PID control is represented by Equations (3) to (5).

$$[ Equation 3 ]$$

$${δ}_{x} = - ( {K}_{P} {q}_{ex} + {K}_{J} \int {q}_{e x} dt + {K}_{D} {\dot{q}}_{ex} ) \qquad ( 3 )$$

$$[ Equation 4 ]$$

$${δ}_{y} = - ( {K}_{P} {q}_{ey} + {K}_{D} {\dot{q}}_{ey} ) + {K}_{J} {ω}_{z} \qquad ( 4 )$$

$$[ Equation 5 ]$$

$${δ}_{z} = - ( {K}_{P} {q}_{e z} + {K}_{D} {\dot{q}}_{e z} ) + {K}_{J} {ω}_{y} \qquad ( 5 )$$

In Equations, δₓ represents a rudder angle of the twist of the wings 20, that is, a twist angle, δ_{y} represents a rudder angle of an elevator, and δ_{z} represents a rudder angle of a rudder. K_{P} represents a proportional gain, K_{I} represents an integral gain, and K_{D} represents a differential gain. Kⱼ is a gain for correcting a gyroscopic moment of the fuselage.

Correction terms (Kⱼω_{y}, Kⱼω_{z}) considering the influence of a thrust gyro effect are added to the third term on the right side for the control of the Y_{B} and Z_{B} axes. ω_{z} is the rotational speed of the fuselage about the Z_{B} axis. ω_{y} is the rotational speed of the fuselage around the Y_{B} axis.

For example, as shown in FIG. 4, the control unit 230 calculates the target attitude using an error distance between the current position and the target position of the flight equipment 100. The control unit 230 controls the twist actuator 216 and controls the attitude of the flight equipment 100 based on the calculated target attitude. The target attitude may be instructed from an external device as a command.

### [Process Flow of Control Unit]

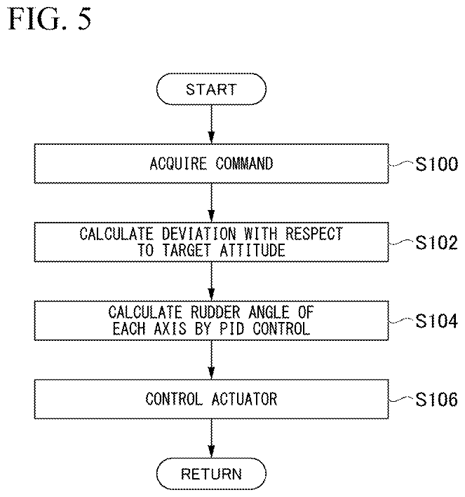

A flow of a series of processes of the control unit 230 will be described below using a flowchart. FIG. 5 is a flowchart showing a series of processes of the control unit 230. The processes of this flowchart may be performed repeatedly at a predetermined cycle, for example.

First, the control unit 230 acquires a command from an external device via the communication unit 202 (Step S100). The command includes, for example, an attitude that the flight equipment 100 should take, that is, the target attitude qᵣ.

Next, the control unit 230 calculates the current attitude q_{c} of the flight equipment 100 based on the detection result of the detection unit 204, and calculates the deviation qₑ between the calculated current attitude q_{c} and the target attitude qᵣ (Step S102). The deviation qₑ includes quaternions q_{ex, ey}, and _{ez} corresponding to the fuselage-fixed coordinate X_{B}, Y_{B}, and Z_{B} axes.

Next, based on the calculated deviation qₑ, the control unit 230 calculates the rudder angle δₓ of the twist, the rudder angle δ_{y} of the elevator, and the rudder angle δ_{z} of the rudder as control variables by the PID control (Step S104).

Next, the control unit 230 sends control signals based on the calculated rudder angles δₓ, δ_{y}, δ_{z} to each of the actuators to control each of the actuators (Step S106). Thus, the processes of this flowchart end.

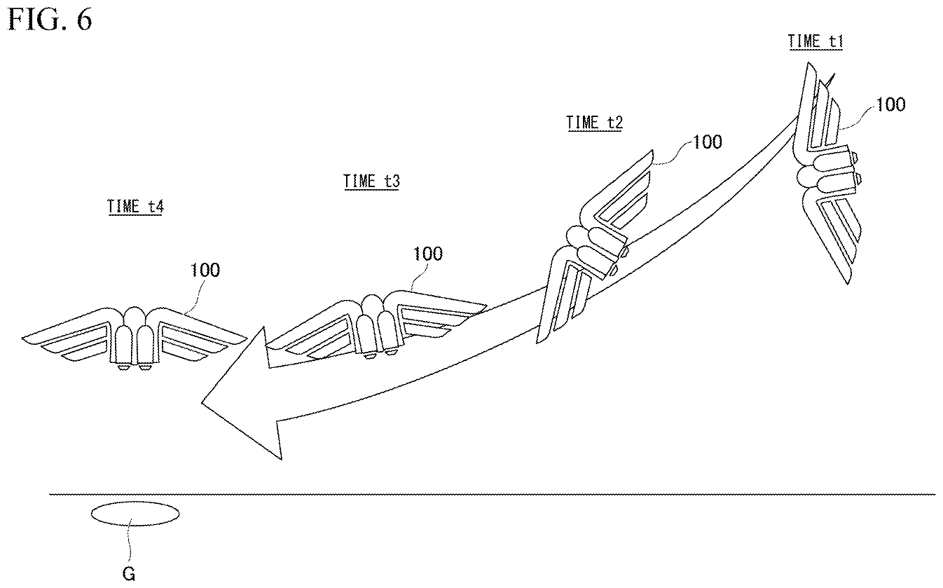

FIG. 6 is a diagram schematically showing a state in which the flight equipment 100 flies. The example shown in the drawing shows a state when the flight equipment 100, which is flying horizontally at a constant altitude, lands. G in the drawing is a target landing point. The landing point G may be a one-dimensional point, a two-dimensional surface, or a three-dimensional space.

For example, assuming that the communication unit 202 receives a command for landing the flight equipment 100 from an external device at time t1, in this case, the control unit 230 controls the sweep actuator 214 to rotate the wings 20 around the yaw axis Z_{B}, thereby moving the wings 20 forward of the fuselage. Thus, the nose of the flight equipment 100 rises.

Further, the control unit 230 controls the fold actuator 218 to spread the wings 20 further in the direction of the pitch axis Y_{B}. Also, the control unit 230 raises the nose of the flight equipment 100. Thus, the flight equipment 100 shifts to the 90-degree pitch-up state while lifting the fuselage at times t2, t3, and t4. As a result, the flight equipment 100 can quickly decelerate because a drag force of the entire fuselage increases. When the flight equipment 100 is in the pitch-up state, the control unit 230 controls the thrust actuator 212 to lower the flight equipment 100 to the destination B while hovering.

According to the first example of control described above, the wings 20 spreads in the direction of the pitch axis Y_{B}. Thus, stall can be curbed by obtaining an aerodynamic force. As a result, the flight performance of the flight equipment 100 can be improved.

Further, according to the first example of control described above, an amount of change in a wing area and a shape of each of the wings 20 can be increased by further including a sweep mechanism that rotates the wings 20 around the yaw axis Z_{B} and moves the wings 20 in the forward and rearward direction of the fuselage, and a twist mechanism that rotates the wings 20 around the pitch axis Y_{B} and internally or externally rotates the wings 20 with respect to the flight equipment 100 in addition to the fold mechanism that spreads and contracts the wings 20 in the direction of the pitch axis Y_{B}. As a result, a change in lift force and moment is increased, and agility of the flight equipment 100 can be improved.

The both wings 20 described above can perform sweep, twist and fold operations symmetrically or asymmetrically. Further, the wings 20 are also applicable not only to a flight structure application, but also to wind or tidal power blades and other structures that receive a force from a fluid.

### [Second Example of Control]

A second example of control will be described below. The second example of control is different from the first example of control described above in that deep reinforcement learning is used to determine an amount of control for each of the sweep mechanism, the twist mechanism, and the fold mechanism based on the attitude, the speed, and the like of the flight equipment 100. In the following, differences from the first example of control will be mainly described, and description of points common to the first example of control will be omitted. In the explanation of the second example of control, the same parts as those in the first example of control are given the same reference numerals.

One of the deep reinforcement learning includes, for example, a deep Q-network (DQN). The DQN is a method of learning an action value function Q (sₜ, aₜ), which represents a value when a certain action aₜ is selected under a certain state variable sₜ at a certain time t as a function, as an approximation function in a neural network in a reinforcement learning called Q-learning.

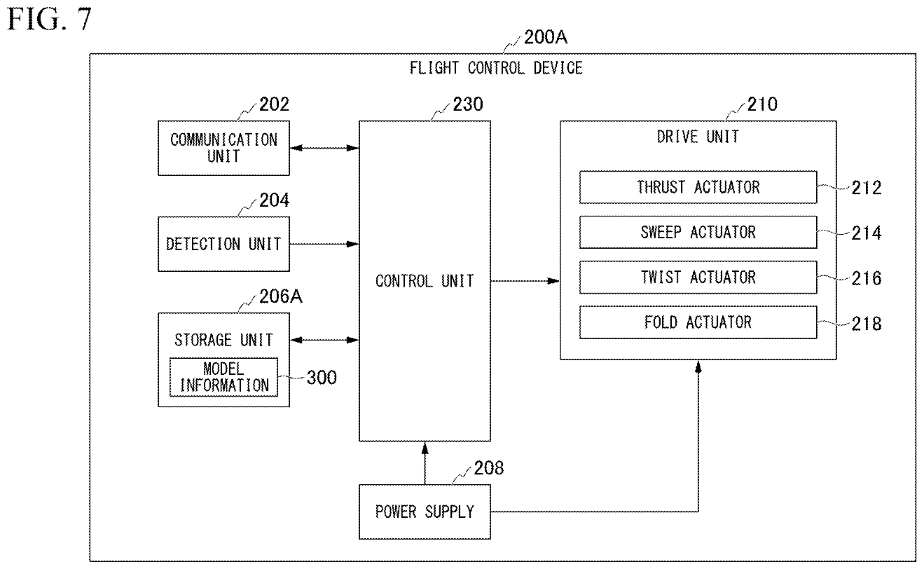

FIG. 7 is a diagram showing an example of a configuration of a flight control device 200A in the second example of control. In the flight control device 200A of the second example of control, model information 300 is stored in a storage unit 206A.

The model information 300 is information (a program or a data structure) that defines a model MDL learned by the Q-learning. The model MDL may be realized, for example, by a neural network including a plurality of convolutional layers and a fully connected layer that integrates output results of the plurality of convolutional layers.

The model information 300 includes, for example, connection information about how units included in each of an input layer, one or more hidden layers (intermediate layers), and an output layer that constitute each of the neural networks are connected to each other, or various types of information such as a coupling coefficient assigned to data input and output between the coupled units. The connection information includes, for example, information that identifies the number of units included in each of the layers, and a type of unit to which each of the units is connected, and information such as an activation function that realizes each of the units and a gate provided between the units of the hidden layers. The activation function that realizes the unit may be, for example, a normalized linear function (a ReLU function), a sigmoid function, a step function, or other functions. The gate selectively passes or weights data communicated between the units, for example, according to a value (for example, 1 or 0) returned by the activation function. The coupling coefficient includes, for example, a weight given to output data when data is output from a unit in a certain layer to a unit in a deeper layer in the hidden layers of the neural network. The coupling coefficient may also include an inherent bias component of each of the layers, and the like.

The model MDL is learned to output the action value function Q(sₜ, aₜ), for example, when a state variable sₜ is input.

The state variable sₜ is, for example, the current attitude q_{c} or the target attitude qᵣ of the flight equipment 100 described above, or the deviation qₑ therebetween. Also, the state variable sₜ may include the speed of the flight equipment 100 instead of or in addition to the attitude and the deviation. Further, when the detection unit 204 includes an optical fiber sensor that detects the strain or a pressure sensor that detects the pressure, the state variable sₜ may include a strain and a pressure that can be obtained from the sensors. The state variable sₜ including the strain and the pressure is an example of “displacement information.”

The action aₜ is, for example, the amount of control of the sweep mechanism, the amount of control of the twist mechanism, the amount of control of the fold mechanism, the rotational speed of the thrust device 10, the rudder angle of the elevator, the rudder angle of the rudder, and the like. That is, the action aₜ is an amount of operation of each of the actuators of the drive unit 210. Also, the action aₜ may be a proportional gain K_{P}, an integral gain K_{I}, a differential gain K_{D}, or a correction gain Kⱼ of the PID control. Also, the action aₜ may be an index value indicating which of various controls such as PID control and hovering control is to be performed or not performed.

In the Q-learning, for example, the weight and bias of the model MDL are learned by increasing a reward when the wings 20, the thrust device 10, the elevator, and the rudder are in ideal states. For example, in the sky above the determined landing point G, the reward may be increased when the attitude of the flight equipment 100 is in a 90-degree pitch-up attitude and the speed of the flight equipment 100 is at a speed that can be regarded as stationary. On the other hand, the reward may be low (for example, zero) when the flight equipment 100 is in contact with the ground or trees, or deviates from a determined altitude.

The control unit 230 inputs the current attitude q_{c} and the target attitude qᵣ of the flight equipment 100 as state variables sₜ to the model MDL that has been learned so that a reward is given according to the action aₜ. The model MDL to which the state variables sₜ are input outputs an amount of operation of each of the actuators that tends to produce the highest reward as the action value function Q(sₜ, aₜ).

The control unit 230 causes the flight equipment 100 to fly by controlling the actuators based on the amount of operation of each of the actuators output by the model MDL.

According to the second example of control described above, since each of the actuators is controlled using the model MDL that has learned in advance by the Q-learning, it is possible to approximate a flight method of a bird. As a result, the agility of the flight equipment 100 can be further improved.

Further, according to the second example of control described above, in the flight action by the sweep mechanism, the twist mechanism and the fold mechanism, although there is a large nonlinearity in the relationship between an input and movement as a response to the input, the model MDL can be learned so that it can output appropriate actions even in a nonlinear environment, and thus it is possible to adopt a flight method that was difficult with conventional control.

### (Operation Method of Flight Equipment)

Next, an operation method using the flight equipment 100 and the flight control device 200 mounted in the flight equipment 100 will be described. As shown in FIG. 1, the operation according to this embodiment is performed when a plurality of users H share one piece of flight equipment 100 and travel from a departure point A to a destination B.

### (When the Flight Equipment is Operated by the User)

First, a case in which the user H flies by operating the flight equipment 100 will be described. That is, a case in which flight is performed by the control unit 230 receiving an input from the user H via an interface will be described.

First, a first user H moves from the departure point A to the destination B. At that time, first, the user H wears the flight equipment 100 at the departure point A. Next, the user H operates the interface to activate the flight equipment 100 and to instruct the thrust device 10 to output, thereby taking off in the vertical direction. At this time, the wings 20 are retracted by the fold mechanism. When there are obstacles such as trees around the departure point A, the wings 20 are fully retracted by the fold mechanism. The wings 20 may be deployed when the aerodynamic force, such as wake of the thrust device 10, are desired during takeoff. The deployment of the wings 20 may be performed by the user H, or may assist the user H by automatically deploying the wings 20 fully by the control unit 230 upon activation of the flight equipment 100.

After taking off to a sufficient height by the flight equipment 100, it shifts to level flight. That is, the user H rotates the wings 20 in the direction of the pitch axis Y_{B} by the twist mechanism, or rotates them in the direction of the yaw axis Z_{B} by the sweep mechanism, and shifts to a forward-leaning attitude. At this time, the wings 20 may be retracted during flight to reduce air resistance. Then wings 20 may be deployed during flight to obtain a lift force.

The user H adjusts a flight attitude, a flight height, a flight direction, and a flight speed by appropriately operating the interface during flight. The interface may display a map or the like that displays a current flight position.

After approaching the destination by level flight, it shifts to a landing attitude. That is, the user H rotates the wings 20 in the direction of the pitch axis Y_{B} or rotates them in the direction of the yaw axis Z_{B} by the sweep mechanism, and shifts from the forward leaning attitude to an upright attitude. At this time, the wings 20 are retracted by the fold mechanism. When there are obstacles, such as trees, around the destination B, the wings 20 are fully retracted by the fold mechanism. The wings 20 may be deployed when the aerodynamic force, such as the wake of thrust device 10, is desired during landing. The deployment of the wings 20 may be performed by the user H, or may assist the user H by automatically deploying the wings 20 when the control unit 230 senses that the user H has rotated the wings 20 and has shifted to the landing attitude.

After the first user arrives at the destination B by the flight equipment 100, only the flight equipment 100 returns to the departure point A by flying under autonomous control. Then, if necessary, the flight equipment 100 is refueled, and then a second user H wears the flight equipment 100 and moves to the destination B.

### (When Flight Equipment Flies by Autonomous Control)

Next, a case in which the flight equipment 100 flies by autonomous control will be described. The flight by the autonomous control may be performed when only the flight equipment 100 returns from the destination B to the departure point A as described above, and may be performed even when the user H moves from the departure point A to the destination B, or when the user H is not proficient in operating the flight equipment 100.

First, the first user H who arrives at the destination B removes the flight equipment 100. Next, the flight equipment 100 is instructed to return. Specifically, the flight equipment 100 is shifted to the autonomous control by inputting to the control unit 230 via the interface. Alternatively, the detection unit 204 may detect that the user H has removed the flight equipment 100, and then the flight equipment 100 may be automatically shifted to the autonomous control.

The flight equipment 100 that has shifted to the autonomous control returns to the departure point A using the functions described above. That is, the control unit 230 controls the drive unit 210 to take off, and the drive unit 210 adjusts the traveling direction as appropriate with reference to the information about the destination B and the departure point A stored in the storage unit 206 and the information on the current position of the flight equipment 100 detected by the detection unit 204, and when the detection unit 204 detects that the flight equipment 100 is approaching the departure point A, it descends and lands.

When the user H moves from the departure point A to the destination B by the autonomous control of the flight equipment 100, the flight equipment 100 flies by the same control. In this case, the control unit 230 is instructed via the interface to move from the departure point A to the destination B by the automatic control.

Registration of the departure point A and the destination B in the storage unit 206 is performed as follows. That is, when the destination B is determined in advance before departure, the departure point A and the destination B may be registered in the storage unit 206 via the interface or by the communication unit 202 before the flight by the flight equipment 100 is started. When the destination B is not determined before departure (for example, when a rescue worker uses the flight equipment 100, a position of a person to be rescued is unknown and it is necessary to search for the person to be rescued from the air), only the departure point A is registered in the storage unit 206 in advance. Then, the first user H may perform the registration in the storage unit 206 through the interface after use, and the detection unit 204 may detect a place at which the flight equipment 100 first landed, and a position thereof may be automatically registered in the storage unit 206.

Further, when the user H needs to change the destination B during flight, the registered contents in storage unit 206 may be changed by the communication unit 202. In addition, when the user H is not proficient in operating the flight equipment 100, another person who is proficient in the operation may perform the flight operation using the communication unit 202 on the ground.

As described above, the flight equipment 100 according to this embodiment can receive the aerodynamic force during flight by providing the wings 20. Therefore, the attitude control can be performed effectively and stably as compared with a case of flying on a bullet trajectory like a rocket without having the wings 20. In addition, the attitude can be stabilized even during takeoff and landing including vertical takeoff and landing. Furthermore, the lift force generated by the wings 20 can reduce the thrust required for flight and can improve fuel efficiency of the thrust device 10. Therefore, the flight time and the flight duration can be improved. From the points, high flight performance can be provided.

Also, the control unit 230 controls the strength of the thrust force. Thus, since the user H only needs to perform a simple operation such as acceleration or deceleration and a direction change by the wings 20, a more intuitive operation can be achieved. Therefore, the flight equipment 100 does not require a highly skilled operation.

Furthermore, the attachment and detachment unit 30 that the user H can wear or remove easily is provided. Thus, the flight equipment 100 can be shared by a plurality of people.

Also, the control unit 230 performs the control of the flight attitude and the flight direction by the wings 20 and the output control of the thrust device 10. Thus, the autonomous flight by the flight equipment 100 is possible. Therefore, the user H can fly without performing any operation. Therefore, the piloting skill of the user H can be made unnecessary.

Furthermore, it is possible to perform autonomous solo flight only with the flight equipment 100 without being worn by the user H. In other words, when a plurality of users H (for example, rescue workers) are going to move from the departure point A to the destination B, one user H moves from the departure point A to the destination B, and then only the flight equipment 100 can return to the departure point A by autonomous flight. Therefore, even when the plurality of users H move from the departure point A to the destination B, the one piece of flight equipment 100 can be used. Therefore, it is possible to contribute to efficient rescue operations without preparing a plurality of flight equipments 100.

Moreover, an attitude sensor is further provided. More stable autonomous flight can be achieved using information detected by the attitude sensor for control by the control unit 230. Furthermore, even when the user H flies with his/her own skill, more stable flight can be achieved by supplementally using information from the attitude sensor.

A position sensor is also provided. Thus, for example, the control unit 230 can select the shortest route for flight by registering the departure point A and the destination B in the flight equipment 100 in advance.

Moreover, the communication unit 202 is further provided. Thus, the flight can be performed by remote control from the outside, in addition to the piloting by the user H and the flight controlled by the control unit 230.

Also, the wings 20 can be folded. Therefore, it is possible to improve the mobility when the flight equipment 100 is carried. Furthermore, during high-speed flight, the wings 20 can be retracted to reduce resistance, and during low-speed flight or takeoff and landing, the wings 20 can be deployed to make it easier to obtain the aerodynamic force. Therefore, it is possible to further improve the mobility.

In addition, after the user H wears the flight equipment 100 and flies from the departure point A to the destination B using the flight equipment, only the flight equipment 100 flies from the destination B to the departure point A. Thus, one piece of flight equipment 100 can be shared by the plurality of users H. Therefore, it is not necessary to prepare a plurality of flight equipment 100, and a plurality of people can be moved.

The technical scope of the present invention is not limited to the above embodiment, and various modifications can be made without departing from the scope of the present invention.

For example, it may be possible to switch between a flight mode operated by the user H and an autonomous flight mode operated by the control unit 230.

Also, during flight, the user H may use some method to record an arbitrary point in position information output by the position sensor at any time. Thus, for example, it may be possible to contribute to more efficient rescue activities by registering in the recording unit a point at which the user H found a person to be rescued in the sky.

Also, the wings 20 may be replaceable according to physique of the user H, weather at the flight site, and the like.

Also, the flight equipment 100 may have a tail. For example, when the user H is wearing the flight equipment 100, the tail may be retracted, and the tail may be deployed when autonomous solo flight is performed.

Also, the user H may remove the flight equipment 100 from the body in the air during flight. After that, the user H may descend to the destination B using parachute or the like. At that time, the flight equipment 100 may detect that it has been removed from the user H and may return by automatic flight.

In addition, it is possible to appropriately replace the constituent elements in the above-described embodiment with well-known constituent elements without departing from the spirit of the present invention, and the modified examples described above may be combined as appropriate.

### INDUSTRIAL APPLICABILITY

According to the present invention, it is possible to provide flight equipment that has high flight performance and does not require a highly skilled operations that require a long time to become proficient.

### REFERENCE SIGNS LIST

10 Thrust device
20 Wing
30 Attachment and detachment unit
100 Flight equipment
230 Control unit
A Departure point
B Destination
H User

1. Flight equipment comprising:
a thrust device configured to provide thrust during flight;
wings configured to maintain an attitude during flight and to change a direction of flight;
a control unit configured to control strength of an output of the thrust device; and
an attachment and detachment unit configured to be worn or removed by a user.

2. The flight equipment according to claim 1, wherein the control unit controls a flight attitude and a flight direction due to the wings and the output of the thrust device.

3. The flight equipment according to claim 1, further comprising an attitude sensor configured to detect an attitude of the flight equipment.

4. The flight equipment according to claim 1, further comprising a position sensor configured to grasp a flying point.

5. The flight equipment according to claim 1, further comprising a communication unit configured to communicate with an outside.

6. The flight equipment according to claim 1, wherein the wing is configured to be folded.

7. An operation method in which a plurality of users share the flight equipment according to claim 1,
wherein, after a user wears the flight equipment and flies from a departure point to a destination using the flight equipment, only the flight equipment flies from the destination to the departure point.
